(19) United States
(12) Patent Application Publication
(10) Pub. No.: US 2008/0295729 A1
(43) Pub. Date: Dec. 4, 2008

(54) Corrosion Inhibitor For Hermetic Lids For Packaged Products, And Method And System For The Application Thereof

(76) Inventors: Maria Margarita Guajardo Trevino, Nuevo Leon (MX); Maria Guadalupe Salazar Alvarez, Nuevo Leon (MX); Samuel Serrano Salinas, Nuevo Leon (MX)

Correspondence Address: MICHAEL WINFIELD GOLTRY, 4000 N. CENTRAL AVENUE, SUITE 1220, PHOENIX, AZ, 85012, US

(21) Appl. No.: 11/572,418

(22) PCT Filed: Jul. 15, 2005
(86) PCT No.: PCT/MX2005/000056

§ 371 Date: Jan. 19, 2007

(30) Foreign Application Priority Data
Jul. 21, 2004 (MX) NL/A/2004/000061

(51) Int. Cl. C09D 5/08; B65D 41/00

(52) U.S. Cl. 106/14.44; 215/316

(57) ABSTRACT

A corrosion inhibitor for metallic crown caps used in packed products. The corrosion inhibitor comprises: one or more zinc sources of food grade, such as zinc oxide; one or more acid sources like carboxylic acids, such as citrus acid; a pH regulator compouse, such as sodium hydroxide; and water, preferably soft water, as aqueous phase for the concentrate formed by the combination of said compounds, as well as soft water as a concentrate solvent for its application. A method and system for applying the corrosion inhibitor is also presented, which ensure that the corrosion inhibitor impregnates both the crown cap perimeter rim and the crown cap internal surface adjacent to the surface of the nozzle of the container.

### TECHNICAL FIELD OF THE INVENTION

This invention relates to a corrosion inhibitor compound and to an application method and system of the same to prevent corrosion on the metallic parts of containers used for packing drinks, food or other products; especially to prevent corrosion in metallic crown caps used for said containers.

### BACKGROUND OF THE INVENTION

Nowadays, drinks, foods, and packed products are available in several kinds of containers; such as glass bottles that during their manufacturing and filling processes their nozzles are closed with crown caps, which are usually made of metal. Such crown caps, typically called crown caps, caps, or tops are manufactured from a metallic plate or sheet, then a cutting and printing process is applied to it, as well as an ink printing and varnishing process; in addition, a plastic liner is added to it to form the internal seal of the crown cap. Before this, the metallic plate or sheet can be treated with a galvanizing process in order to prevent its corrosion.

During the different cutting and printing process stages of the metallic plate or sheet in which crown caps are formed, a perimeter rim is generated with an unprotected edge against corrosion, in such a way that when the crown cap is installed over the container nozzle, the perimeter rim of the crown cap is exposed to the environmental conditions in which the packed products are immersed.

When the crown cap is placed over the container nozzle and it is exposed to the conditions that initiate corrosion, the perimeter rim is attacked by this phenomenon which shows up as metallic oxide, and tends to deposit itself inside the crown cap and also inside the container upper rim; then, when the crown cap is removed to consume the product, the oxide residues adhered to the nozzle edge produce a bad appearance and can also become a contamination source for the packed product and for the consumer.

In addition to this, most of the corrosion inhibitors compounds, zinc-based, used for the treatment of metallic plates or surfaces contain in their formulations compounds and/or concentrations which are generally out of permissible standards. Thus, it is not feasible to use them as a second stage treatment to prevent corrosion once the crown cap is printed and cut because the operation costs would increase, and applying them when the crown cap is placed over the container nozzle would be the least advisable because they would be a contamination source for the consumer.

### SUMMARY OF THE INVENTION

According to what has been previously described, the object of the present invention is to provide a corrosion inhibitor for crown caps and a method and system for its application, having the inhibitor cost-effective, free of contaminant compounds and whose concentrations of active compounds do not harm health; additionally, being applied once a crown cap is placed over the container nozzle.

In addition to this, it is also the objective of the present invention to provide a system and a method for applying the corrosion inhibitor to a crown cap once it is placed over the container nozzle.

### BRIEF DESCRIPTION OF THE FIGURES

The proper details of the method and system for applying a corrosion inhibitor to metallic crown caps are described in the “application mode” section, as well as in the figures that come with it, whose purpose is to define the method and system, but without restricting its scope.

FIG. 1 illustrates a schematic diagram of the present invention of a system for applying a corrosion inhibitor on crown caps.

FIGS. 2A and 2B illustrate a lateral and superior view of a spray orientation of the corrosion inhibitor for metallic crown caps seen from FIG. 1 perspective.

### DETAILED DESCRIPTION OF THE INVENTION

First, the proper and composition details of the corrosion inhibitor for metallic crown caps are described in the following paragraphs, whose purpose is to define the features and composition of such inhibitor, but without restricting its scope.

The corrosion inhibitor for metallic crown caps shows components that can also consist of multiple components in its concentrate composition.

The components are individually described below.

### Component I

The corrosion inhibitor for metallic crown caps contains an active component I, which is one or more zinc sources of food grade which can be metallic zinc, zinc oxide, or a mixture of these.

We found that zinc salt, such as zinc gluconate, zinc chloride, zinc sulphate, zinc carbonate, zinc citrate, or a mixture of these can be used as Component I, among other zinc sources of food grade.

### Component II

The corrosion inhibitor for crown caps contains an active component II, which is one or more acid sources that can be carboxylic acids, such as citrus acid, its salt, or a mixture of these.

Acetic acid, adipic acid, alginic acid, lactic acid, estearic acid, tartaric acid, tannic acid, succinic acid, or a mixture of these can also be the carboxylic acid used in the composition.

Other kind of acid sources used are: sulphuric acid, glutamic acid, gluconic acid, phosphoric acid, ascorbic acid, eritorbic acid, sorbic acid, hydrochloric acid, or a mixture of these.

### Component III

The corrosion inhibitor for crown caps contains a component III, which is a regulator component of pH, such as sodium hydroxide, potassium hydroxide, ammonium hydroxide, or a mixture of these, which give stabilization features to the corrosion inhibitor and avoid its precipitation. The pH range of the corrosion inhibitor is from pH 2 to pH 8.

### Component IV

The corrosion inhibitor for metallic crown caps contains water as component IV as aqueous phase for the dispersion of the remaining components during the concentrate preparation of the corrosion inhibitor. It is best to use soft water for this purpose.

Once the corrosion inhibitor for metallic crown caps is elaborated as a concentrate, it is then diluted in water, preferably soft water, to provide an easy application on the crown caps.

### Concentrate Blend

The corrosion inhibitor for metallic crown caps, in its elaboration as a concentrate, combines components I, II, III, and IV in the following weight percentage concentrations:
(a) from 0.0005% to 50% of the zinc source (component I);
(b) from 0.001% to 60% of the acid source (component II);
(c) from 0.001% to 25% of the pH regulator composite (component III); and
(d) from 0% to 99.997% of water (component IV).

Table 1 illustrates examples of the corrosion inhibitor composition for metallic crown caps, in concentrate form, showing the weight percentage concentrations of each component, its operative pH and the corrosion residues found in the nozzles of the test glass containers:

TABLE 1

Weight percentage of each component

| Compound | Ex. 1 | Ex. 2 | Ex. 3 |
|---|---|---|---|
| Zinc oxide | 5.50 | 0 | 0 |
| Zinc sulphate | 0 | 22.60 | 0 |
| Metallic zinc | 0 | 0 | 45 |
| Citric acid | 14.50 | 0 | 0 |
| Gluconic acid in | 0 | 54.90 | 0 |
| aqueous solution | | | |
| Hydrochloric acid | 0 | 0 | 55 |
| in aqueous | | | |
| solution | | | |
| Sodium hydroxide | 12.00 | 22.50 | 0 |
| Potasium hydroxide | 0 | 0 | 0 |
| Soft water as | 68.00 | 0 | 0 |
| aqueous phase for | | | |
| the concentrate | | | |
| pH | 6.0 | 6.7 | 2.3 |
| Corrosion present | No | No | No |

In a particular embodiment in its concentrate composition, the corrosion inhibitor for metallic crown caps shows the following content in weight percentage concentrations:
(a) from 0.00055% to 15% of zinc oxide (component I);
(b) from 0.00145% to 20% of citric acid (component II);
(c) from 0.0012% to 24% of sodium hydroxide (component III); and
(d) from 41 to 99.997% of soft water (component IV).

Table 2 illustrates examples of corrosion inhibitor composition for metallic crown caps, in concentrate form, showing the weight percentage concentrations for each component, its operative pH and the corrosion residues found in the nozzles of the test glass containers:

TABLE 2

Weight percentage of each component

| Compound | Ex. 1 | Ex. 2 | Ex. 3 |
|---|---|---|---|
| Zinc oxide | 5.50 | 6.20 | 4.40 |
| Citric acid | 14.50 | 15.80 | 11.60 |
| Sodium hydroxide | 12.00 | 10.00 | 9.60 |
| Soft water as | 68.00 | 68.00 | 74.40 |
| aqueous phase for | | | |
| the concentrate | | | |
| pH | 6.0 | 6.5 | 6.4 |
| Corrosion present | No | No | No |

### Concentrate Dilution

The corrosion inhibitor concentrate for metallic crown caps is dissolved in water to facilitate its application on metallic crown caps, according to the following weight percentage concentrations:
(a) from 0.01% to 100% of the corrosion inhibitor concentrate (component I+component II+component III+component IV) and
(b) from 0% to 99.99% of water as solvent.

Table 3 illustrates examples of corrosion inhibitor composition for metallic crown caps, in diluted form, showing the weight percentage concentration of each component, its operative pH, and the corrosion residues in the nozzles of the test glass containers:

TABLE 3

| | Weight percentage of each component | | | | | |
|---|---|---|---|---|---|---|
| Compound | Ex. 1 | Ex. 2 | Ex. 3 | Ex. 4 | Ex. 5 | Ex. 6 |
| Concentrate | 10 | 20 | 50 | 2 | 1 | 0.5 |
| (component I + | | | | | | |
| component II + | | | | | | |
| component III + | | | | | | |
| component IV) | | | | | | |
| Soft water as | 90 | 80 | 50 | 98 | 99 | 99.5 |
| solvent of the | | | | | | |
| concentrate | | | | | | |
| pH | 7.62 | 7.43 | 7.14 | 7.59 | 7.75 | 7.80 |
| Corrosion present | No | No | No | No | No | No |

### Concentrate Preparation Mode

The corrosion inhibitor concentrate for metallic crown caps is prepared, for example, at a temperature from 40° C. to 60° C.; where, first, an aqueous solution of soft water and acid source is prepared (component IV); later, a zinc source is slowly added (component I), being shaken vigorously afterwards; slowly adding the pH regulator component (component III) to stabilize the solution and to avoid reaction precipitation from the zinc source and acid source, and additionally to regulate the pH desired in the concentrate, in the range of pH 2 to pH 8.

Finally, the active composition (component I+component II+component III) is diluted in dilution water in the right amounts according to the application requirements.

### Application Mode

The corrosion inhibitor for metallic crown caps can be applied immersing the crown cap that is placed in the container nozzle, in a recipient with corrosion inhibitor; another application alternative is to spray the corrosion inhibitor manually on the crown cap using a paintbrush, sponge, tow, etc. In all cases, it the corrosion inhibitor must be permitted to impregnate the crown cap rim, as well as the crown cap inner surface adjacent to the container nozzle surface.

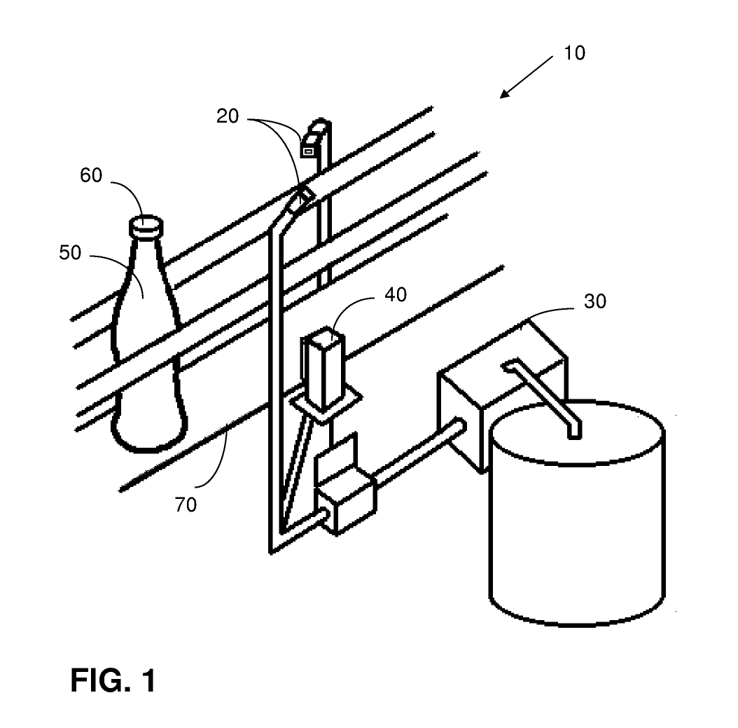

In the case of the spray application alternative, FIG. 1 shows the application system of a corrosion inhibitor in crown caps providing a smooth and optimum application of the right amount of corrosion inhibitor for that purpose. Here, system 10 has a couple of spray nozzles 20 generally placed opposite each other, with a lightly ascendant spray angle directed to the base or perimeter rim of the crown cap, specially towards its edge. Such spray nozzles 20 are connected to a pneumatic system 30 that contains the corrosion inhibitor. System 10 has a proximity detector 40 to detect the presence of container 50 with crown cap 60 placed when containers 50 are transported through chain conveyor 70.

Under configuration of system 10, containers 50 are transported through a conveyor belt 70 to system 10 for the corrosion inhibitor application. When container 50, with crown cap 60 installed, is near spray nozzles 20, the latter is detected by proximity detector 40, which orders the pneumatic system 30 to spray the corrosion inhibitor on crown cap 60 through spray nozzles 20, favoring the impregnation and adherence of the corrosion inhibitor to the perimeter rim of crown cap 60, as well as to the inner surface of it, which is adjacent to container nozzle surface 50. Finally, allow the corrosion inhibitor to dry and to form a corrosion inhibitor layer in crown cap 60.

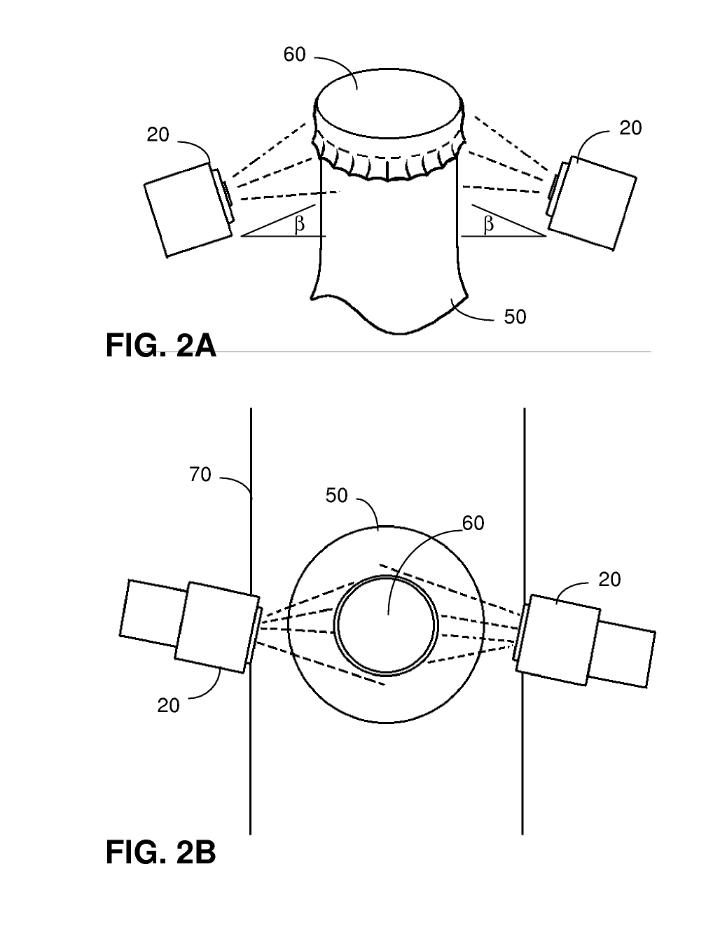

Referring to FIGS. 2A and 2B, which illustrate a lateral and superior view of the spray orientation of corrosion inhibitor for metallic crown caps, seen from FIG. 1 perspective. In order to promote the corrosion inhibitor's impregnation and adherence to the perimeter rim of crown cap 60, as well as to the inner surface of it, which is adjacent to container nozzle surface 50; spray nozzles 20 are generally placed opposite each other with a lightly ascendant angle β directed to crown cap 60 in container 50, specially to the base or perimeter rim of crown cap 60, specially towards its exposed edge.

Based on the previously described composition embodiments of the corrosion inhibitor, it is contemplated that the modifications of described composition and embodiments, as well as the alternative composition and embodiments, will be considered as evident for an expert person in the art under the present description. Therefore, it is considered that the claims include said modifications and alternatives that are in the scope of the corrosion inhibitor of this invention.

1. A corrosion inhibitor to prevent corrosion in crown caps for packed products containers, said corrosion inhibitor comprising a premixed composition including:
a quantity of a zinc source of food grade;
a quantity of an acid source; and
a quantity of a pH compound regulator.

2. The corrosion inhibitor of claim 1, wherein said quantity of zinc source of food grade includes at least about 0.0005% by weight of the zinc source food grade.

3. The corrosion inhibitor of claim 1, wherein said quantity of zinc source of food grade includes no more than about 50% by weight of the zinc source food grade.

4. The corrosion inhibitor of claim 1, wherein said zinc source of food grade is selected from a group consisting of metallic zinc, zinc oxide, zinc salts, and mixtures thereof.

5. The corrosion inhibitor of claim 1, wherein said quantity of zinc source of food grade comprises at least about 0.00055% by weight of zinc oxide.

6. The corrosion inhibitor of claim 1, wherein said quantity of zinc source of food grade comprises no more than about 15% by weight of zinc oxide.

7. The corrosion inhibitor of claim 4, wherein said zinc salt is selected from a group consisting of zinc gluconate, zinc chloride, zinc sulphate, zinc carbonate, zinc citrate, and mixtures thereof.

8. The corrosion inhibitor of claim 1, wherein said quantity of acid source includes at least about 0.001% by weight of the acid source.

9. The corrosion inhibitor of claim 1, wherein said quantity of acid source includes no more than about 60% by weight of the acid source.

10. The corrosion inhibitor of claim 1, wherein said acid source comprises a carboxylic acid.

11. The corrosion inhibitor of claim 10, wherein said carboxylic acid is selected from a group consisting of citrus acid, acetic acid, adipic acid, alginic acid, lactic acid, estearic acid, tartaric acid, tannic acid, succinic acid, propionic acid, their salts, and mixtures thereof.

12. The corrosion inhibitor of claim 1, wherein said quantity of acid source comprises at least about 0.00145% by weight of citrus acid.

13. The corrosion inhibitor of claim 1, wherein said quantity of acid source comprises no more than about 20% by weight of citrus acid.

14. The corrosion inhibitor of claim 1, wherein said acid source is selected from a group consisting of sulphuric acid, glutamic acid, gluconic acid, phosphoric acid, ascorbic acid, eritorbic acid, sorbic acid, hydrochloric acid, and mixtures thereof.

15. The corrosion inhibitor of claim 1, wherein said quantity of pH compound regulator includes at least about 0.001% by weight of the pH compound regulator.

16. The corrosion inhibitor of claim 1, wherein said quantity of pH compound regulator includes no more than about 25% by weight of the pH compound regulator.

17. The corrosion inhibitor of claim 1, said quantity of pH compound regulator providing the corrosion inhibitor with a pH value of approximately 2.

18. The corrosion inhibitor of claim 1, said quantity of pH compound regulator providing the corrosion inhibitor with a pH value of at least and not exceeding 8.

19. The corrosion inhibitor of claim 1, wherein said pH compound regulator is selected from a group consisting of sodium hydroxide, potassium hydroxide, ammonium hydroxide, and mixtures thereof.

20. The corrosion inhibitor of amount of claim 1, wherein said quantity of pH compound regulator comprises at least about 0.0012% by weight of sodium hydroxide.

21. The corrosion inhibitor of claim 1, wherein said quantity of pH compound regulator comprises no more than about 24% by weight of sodium hydroxide.

22. The corrosion inhibitor of claim 1, further comprising the quantity of the zinc source of food grade, the quantity of the acid source, and the quantity of the pH compound regulator disposed in a quantity of water.

23. The corrosion inhibitor of claim 22, wherein said quantity of water includes no more than about 99.997% by weight of the water.

24. The corrosion inhibitor of claim 22, wherein said water is soft water.

25. An aqueous solution containing approximately 0.01% by weight of the corrosion inhibitor of claim 1.

26. (canceled)

27. (canceled)

28. The corrosion inhibitor of claim 1, further comprising:
a metallic crown cap having an internal surface; and
the corrosion inhibitor of claim 1 applied to the internal surface preventing corrosion of the internal surface of the metallic crown cap.

29. In a crown cap having an internal surface a method of preventing corrosion of the internal surface of the crown cap comprising the steps of:
providing a corrosion inhibitor comprising a premixed composition of a quantity of a zinc source of food grade, a quantity of an acid source, and a quantity of a pH compound regulator; and
coating the internal surface of the crown cap with at least one layer of the corrosion inhibitor.

30. In a container having a crown cap secured thereto, a method comprising steps of:
providing a corrosion inhibitor comprising a premixed composition of a quantity of a zinc source of food grade, a quantity of an acid source, and a quantity of a pH compound regulator; and
impregnating the crown cap with the corrosion inhibitor preventing corrosion of the crown cap.

31. The method according to claim 30, wherein the step of impregnating includes:
spraying the crown cap with the corrosion inhibitor; and
waiting for the corrosion inhibitor sprayed on the corrosion inhibitor to impregnate the crown cap.
